(19) United States
(12) Patent Application Publication
(10) Pub. No.: US 2014/0062895 A1
(43) Pub. Date: Mar. 6, 2014

(54) FINGERTIP MULTI-TOUCH INPUT DEVICE

(71) Applicants: Al Chakra, Apex, NC (US); John A. Feller, Cary, NC (US); Trudy L. Hewitt, Cary, NC (US); Frank Schembari, Durham, NC (US)

(72) Inventors: Al Chakra, Apex, NC (US); John A. Feller, Cary, NC (US); Trudy L. Hewitt, Cary, NC (US); Frank Schembari, Durham, NC (US)

(21) Appl. No.: 13/599,121

(22) Filed: Aug. 30, 2012

(51) Int. Cl. G06F 3/033; G06F 3/041

(52) U.S. Cl. 345/173; 345/179

(57) ABSTRACT

Some embodiments of the inventive subject matter include a method for using a multi-touch device to enter multi-touch user input on a multi-touch display device. The method can include initiating a multi-touch mode for a computing device including a multi-touch display. The method can also include touching the multi-touch display with a multi-touch device, wherein the multi-touch device includes a sleeve configured to hold the multi-touch device to a finger, and a plurality of nubs connected to the sleeve and protruding radially outward from the sleeve, wherein the plurality of nubs make contact with multi-touch device. The method can also include moving the multi-touch device across the multi-touch touchscreen to provide user input.

### BACKGROUND

Touchscreen devices employ many different technologies to detect input. Common types of touchscreens include resistive touchscreens, surface acoustic wave (SAW) touchscreens, capacitive touchscreens, infrared touchscreens, etc.

Touchscreen devices are typically controlled through user input in the form of touching a desired place or icon on the screen. In addition to touching the screen, many touchscreen devices can be controlled by sliding one or more fingers across the screen. Touchscreen devices can also receive input commands based on predefined gestures.

In addition to receiving input through single data points, many touchscreen devices are able to interpret and process distinct simultaneous inputs through touch input from more than one finger. These devices (multi-touch devices) enable a greater number of predefined gestures. For example, a common multi-touch gesture is the “pinch-to-zoom” gesture. The “pinch-to-zoom” gesture allows a user to enlarge the image displayed on the touchscreen by placing two fingers on the multi-touch touchscreen and then sliding the two fingers apart while remaining in contact with the touchscreen. Another multi-touch feature requires a user to make and maintain contact with the touchscreen with three fingers. Doing so with an iPhone honk. in “accessibility mode” may allow the user to pan an enlarged image.

Although multi-touch devices allow for a greater number of predefined gestures, it can often be difficult or cumbersome to execute gestures requiring the user to make and maintain contact with the touchscreen with more than one finger. Specifically, gestures requiring more than one finger on a small touchscreen can be especially difficult for those with limited dexterity. Furthermore, placing several fingers on the screen and maintaining contact with the display may obstruct the view of the touchscreen making use difficult, affecting the use of the product for those without limited dexterity, etc.

### SUMMARY

Some embodiments of the inventive subject matter include a method for using a multi-touch device to enter multi-touch user input on a multi-touch display device. The method can include initiating a multi-touch mode for a computing device including a multi-touch display. The method can also include touching the multi-touch display with a multi-touch device, wherein the multi-touch device includes a sleeve configured to hold the multi-touch device to a finger, and a plurality of nubs connected to the sleeve and protruding radially outward from the sleeve, wherein the plurality of nubs make contact with multi-touch device. The method can also include moving the multi-touch device across the multi-touch touchscreen to provide user input.

### BRIEF DESCRIPTION OF THE DRAWINGS

The present embodiments may be better understood, and numerous objects, features, and advantages made apparent to those skilled in the art, by referencing the accompanying drawings.

FIG. 1 depicts a perspective view of a user's hand interacting with a touchscreen.

FIG. 2 depicts a user utilizing one embodiment of the inventive subject matter to interact with a touchscreen generating multi-touch input using one finger

FIG. 3 depicts a perspective view of one embodiment of the inventive subject matter wherein the device comprises a sleeve which fits over the user's finger.

FIG. 4a depicts a perspective view of one embodiment of the inventive subject matter wherein the device comprises a sleeve and a plurality of nubs affixed to the sleeve oriented to the anterior surface of the user's hand.

FIG. 4b depicts a perspective view of one embodiment of the inventive subject matter showing the sleeve and the nubs.

FIG. 5a depicts a perspective view of one embodiment of the inventive subject matter wherein the device utilizes three nubs,

FIG. 5b depicts a perspective view of one embodiment of the inventive subject matter wherein the device utilizes four nubs.

FIG. 5c depicts one embodiment of the inventive subject matter wherein the device utilizes five nubs.

FIG. 6 depicts a perspective view of one embodiment of the inventive subject matter wherein the device utilizes a stylus oriented in a plane nonparallel to that of the nubs.

FIG. 7 depicts a flow diagram illustrating the steps a user may take to use the inventive subject matter,

### DESCRIPTION OF EMBODIMENT(S)

Some embodiments of the invention allow a user to make and maintain multiple contact points with a touchscreen using only one linger. In one embodiment, the present invention comprises a sleeve with a plurality of nubs attached to the sleeve. This embodiment may allow the user to utilize pre-defined gestures with one finger as opposed to multiple fingers. Using one finger enables the user to see more of the touchscreen. Additionally, some embodiments of the invention may improve gaming, or other activities requiring rapid successive input from the user by allowing a greater number of available gestures without adding additional hotkeys.

The description that follows includes exemplary models that embody techniques of the present inventive subject matter. However, it is understood that the described embodiments may be practiced without these specific details. For instance, although examples refer to the device comprising a sleeve which fits over the user's finger, other embodiments of the inventive subject might include a ring-shaped apparatus to which the nubs are connected. In other instances, well-known adhesive materials and shapes have not been shown in detail in order not to obfuscate the description.

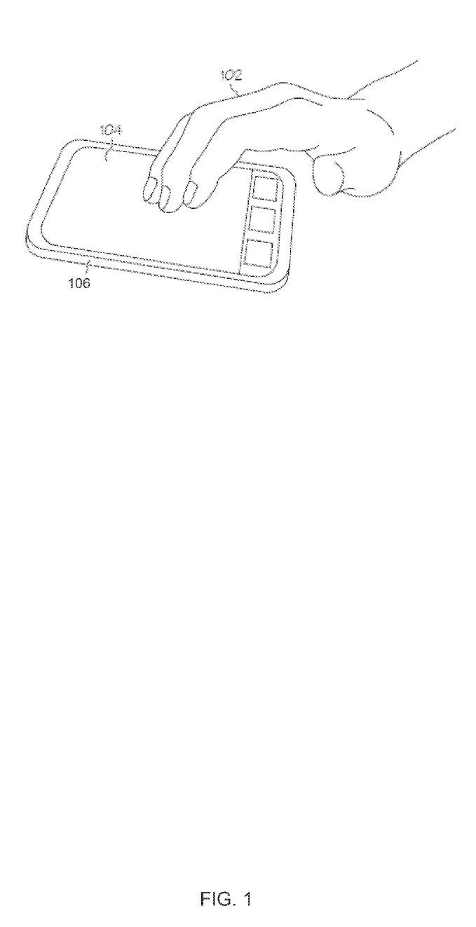

FIG. 1 depicts a perspective view of a user's fingers 102 interacting with a device 106 including a multi-touch touchscreen 104 (“touchscreen”). in FIG. 1, the user's fingers 102 are utilizing a multi-touch mode on the multi-touch touchscreen 104 using multiple fingers 102. The user's fingers 102 interact with the multi-touch touchscreen 104 by contacting the touchscreen 104 with the fingers 104.

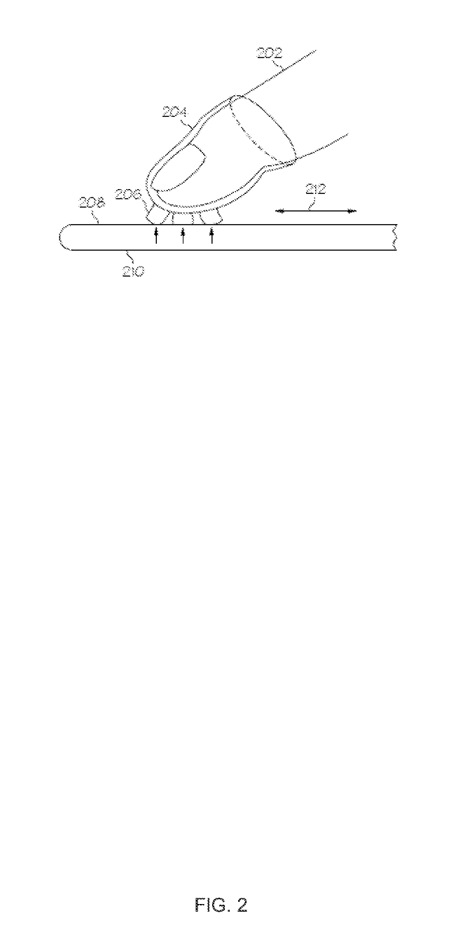

FIG. 2 depicts one embodiment of the inventive subject matter that enables a user to interact with a multi-touch touchscreen 208 generating multi-touch input using one finger 202. in FIG. 2, the touchscreen 208 is affixed to a computing device 210. In FIG. 2, a fingertip multi-touch input device includes a sleeve 204 that fits over the user's finger 202. The nubs 206 are affixed to the anterior side of the sleeve 204. The nubs 206 interact with the touchscreen 208. As shown, the nubs 206 can make contact with the touchscreen 208. Additionally, the nubs 206 may interact with the touchscreen 208 by moving across the touchscreen 208, as shown by arrow 212. In some embodiments, the nubs 206 can interact with the touchscreen 208 without making contact, but by being in close proximity to the touchscreen.

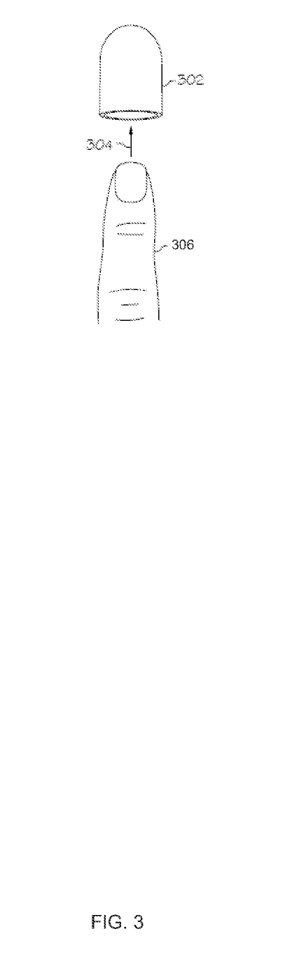

FIG. 3 depicts a perspective view of one embodiment of the inventive subject matter where the device comprises a sleeve 302 which fits over the user's finger 306. FIG. 3 represents a posterior view of the user's finger 306. As shown, the user's finger 306 is inserted into the sleeve 302 as indicated by arrow 304. in some embodiments, the multi-touch device may be worn on more than one finger 306, i.e. one multi-touch device in which the sleeve is worn over more than one finger 306. In other embodiments, more than one multi-touch device may be used simultaneously, i.e. two multi-touch devices being worn one on each of two fingers 306, etc., which may allow a user to perform distinct multi-touch gestures, dependent on the finger 306 and multi-touch device used.

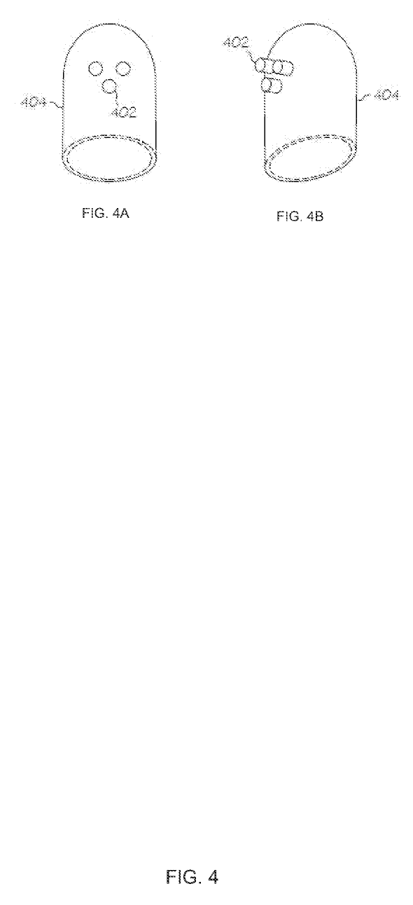

FIG. 4a depicts a perspective view of one embodiment of the inventive subject matter wherein the fingertip multi-touch input device comprises a sleeve 404 and a plurality of nubs 402 affixed to the sleeve 404 oriented to the anterior surface of the user's hand. In some embodiments, the shape of the nubs 402 can be conical, cylindrical (e.g., with rounded or square edges, etc.), spherical, or any other suitable shape to achieve a single contact point for each nub 402 with the touchscreen, additionally, in some embodiments, the nubs 402 may be constructed from a material which does not scratch the touchscreen. In other embodiments, the nubs 402 may be coated with a material that will not scratch the touchscreen.

FIG. 4b depicts a perspective view of one embodiment of the fingertip multi-touch device showing the sleeve 404 and the nubs 402. The view of the inventive subject matter in FIG. 4b is oriented at an angle in a plane non-parallel to nubs 402. It is unnecessary' that the sleeve 404 fully enclose the fingertip. In some embodiments, the sleeve can take the form of a ring to which the nubs 402 are affixed, where the ring connects to the user's finger. The sleeve 404 can also be configurable to accommodate fingers of various sizes as well as fingernails of various lengths. In some embodiments, the sleeve 404 does not cover the entire circumference of the user's finger. For example, the sleeve 404 can resemble a roughly half-cylindrical shape (e.g., a cylinder dissected in a plane non-parallel to the cylinder's radius) which attaches to the user's finger. In other embodiments, the sleeve 404 can take the form of a sphere dissected below the equator resembling a somewhat bowl-shaped sleeve. The sleeve 404 can be constructed from any material. In some embodiments, the sleeve 404 may be constructed from, latex, plastic, fabric, or a conductive material.

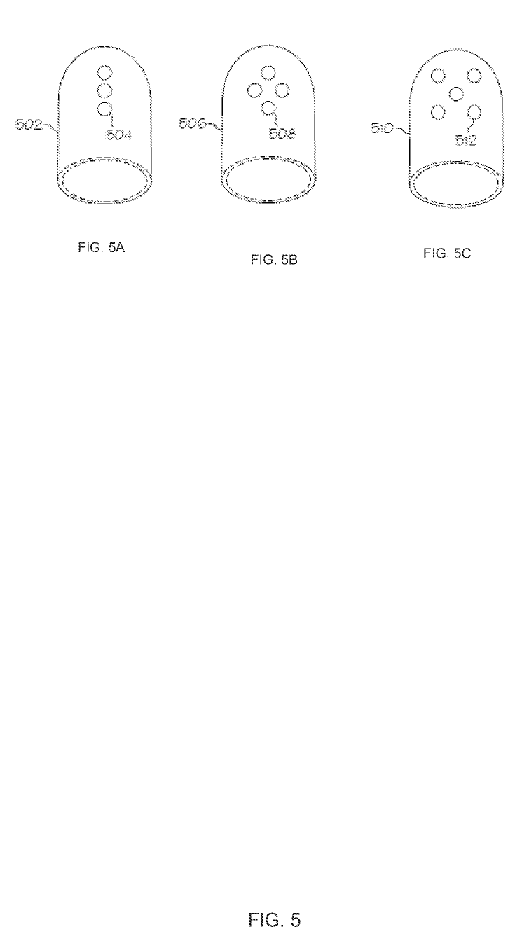

FIG. 5a depicts a perspective view of one embodiment of the inventive subject matter wherein the device utilizes three nubs 504 affixed to the sleeve 502. It is unnecessary that the nubs 504 be oriented in the same plane relative to one another. In some embodiments, the nubs 504 may be oriented in distinct planes, allowing the user to alter the number of nubs 504 making contact with the touchscreen at any one time by pivoting the finger about any axis. Additionally, groupings of nubs 504 could be oriented in the same plane, while other groupings of nubs 504 could be oriented in a distinct common plane. For example, in one embodiment, a multi-touch device could have five nubs 504, three of which are oriented in a plane on the right side of the multi-touch device and two of which are oriented on the left side of the multi-touch device. This configuration may allow a user to select between a five-finger simultaneous touch event, a three-finger simultaneous touch event, and a two-finger simultaneous multi-touch event. In the (previous example, a user may simulate a five-finger simultaneous touch event by contacting the screen with the multi-touch device where the multi-touch device is oriented in a plane similar to that of the touchscreen, allowing five nubs 504 to contact the touchscreen. A user may simulate a three-finger simultaneous touch event by rotating the multi-touch device clockwise from the user's perspective, allowing only three nubs 504 to contact the touchscreen. Similarly, a user may simulate a two-finger simultaneous touch event by rotating the multi-touch device counter-clockwise from the user's perspective, allowing only two nubs 504 to contact the screen.

FIG. 5b depicts a perspective view of one embodiment of the inventive subject matter wherein the device utilizes four nubs 508 affixed to the sleeve 506.

FIG. 5c depicts one embodiment of the inventive subject matter wherein the device utilizes five nubs 512 affixed to the sleeve 510.

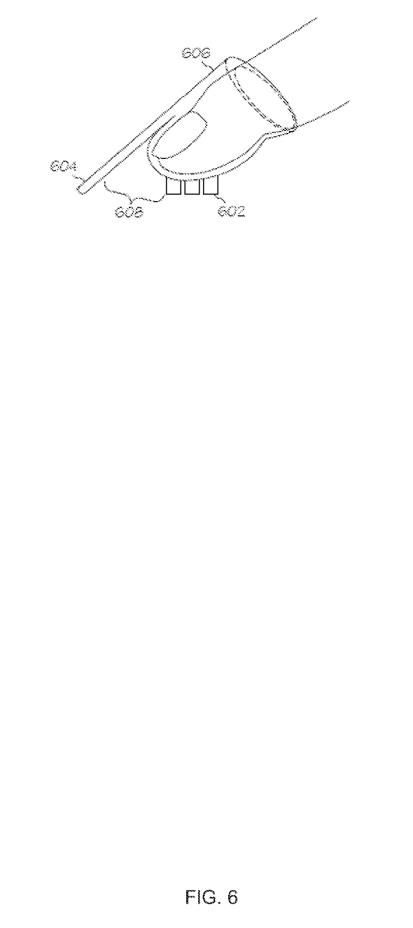

FIG. 6 depicts a perspective view of one embodiment of the inventive subject matter wherein the device utilizes a stylus 604 oriented in a plane non-parallel to that of the nubs 602. As shown, the stylus 604 is affixed to the sleeve 606, As indicated by are 608, the orientation of the stylus is in a plane non-parallel to that of the nubs 602.

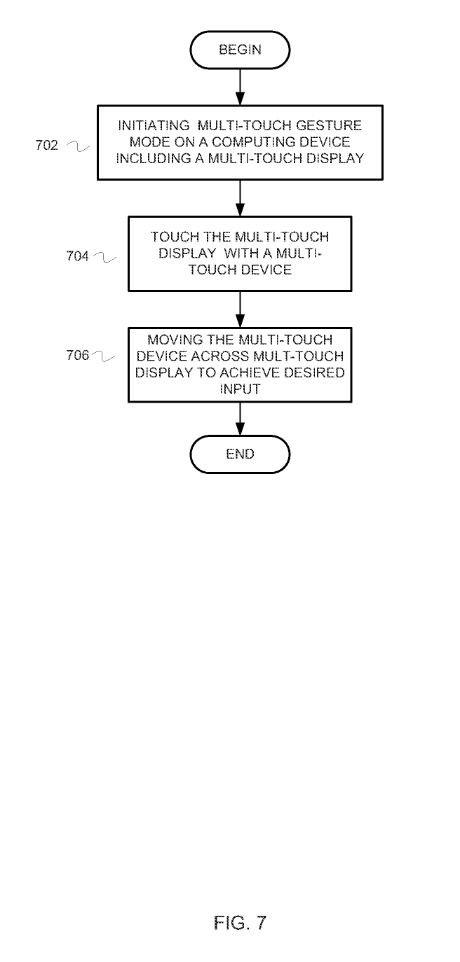

FIG. 7 depicts a flow diagram illustrating operations for using a fingertip multi-touch device to provide multi-touch input to a computing device. The operations of flow 700 begin at block 702, In block 702, a multi-touch gesture mode is initiated within the computing device, allowing multi-touch input to the computing device. The flow continues at block 704.

At block 704, the computing device detects multi-touch input resulting from the fingertip multi-touch device contacting the touchscreen. The flow continues at block 706.

At block 706 the fingertip multi-touch device moves across the computing device's touchscreen. As the fingertip multi-touch device moves across the touchscreen, the fingertip multi-touch device's nubs maintain a plurality of contact points with the touchscreen. The computing device can interpret the movement as multi-touch input. From block 706, the flow ends.

Plural instances may be provided for components, operations or structures described herein as a single instance. Finally, boundaries between various components, operations and data stores are somewhat arbitrary, and particular operations are illustrated. in the context of specific illustrative configurations. Other allocations of functionality are envisioned and may fall within the scope of the inventive subject matter. in general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. An apparatus for entering multi-touch input on a multi-touch touchscreen device, the apparatus comprising:
a finger covering, wherein the finger covering is configured to connect to a user;
a plurality of nubs including a conductive material, wherein the nubs are affixed to the finger covering, and wherein the nubs are configured to be conductively connected to the user to facilitate multi-touch input on the multi-touch touchscreen device.

2. The apparatus of claim 1, further comprising a stylus, wherein the stylus is affixed to the covering.

3. The apparatus of claim 2, wherein the stylus is composed of a conductive material and is conductively connected to the user.

4. The apparatus of claim 1 wherein the finger covering is configured to change size.

5. A method for using a multi-touch device to enter multi-touch user input on a multi-touch touchscreen, the method comprising:
initiating a multi-touch mode for a computing device including a multi-touch touchscreen;
touching the multi-touch touchscreen with a multi-touch device, wherein the multi-touch device includes a sleeve configured to hold the multi-touch device to a finger, and a plurality of nubs connected to the sleeve and protruding radially outward from the sleeve, wherein the nubs are positioned to provide multiple contact points to the multi-touch touchscreen, and wherein the plurality of nubs make contact with the multi-touch device; and
moving the multi-touch device across the multi-touch touchscreen to provide user input.

6. The method of claim 5, wherein the nubs include a conductive material.

7. The method of claim 6, wherein the nubs make contact with a user.

8. The method of claim 5, wherein the nubs are positioned to provide individual contact points on the multi-touch touchscreen.

9. The method of claim 5, wherein the user input provides multiple contact points to the multi-touch touchscreen, wherein the multiple contact points are to initiate a multi-touch mode associated with the multi-touch touchscreen.

10. An apparatus for entering multi-touch input on a multi-touch touchscreen device, the apparatus comprising:
a sleeve, wherein the sleeve is configured to be connected to a user;
a plurality of nubs, wherein the nubs protrude radially outward from the sleeve, and wherein the nubs are positioned to provide multiple contact points to the multi-touch touchscreen,

11. The apparatus of claim 10, wherein the nubs protrude through the sleeve making contact with a user.

12. The apparatus of claim 10, wherein the nubs are conductively connected with the user.

13. The apparatus of claim 10, further comprising;
a stylus, wherein the stylus protrudes radially outward from the sleeve in a plane non-parallel to that of the nubs.

14. The apparatus of claim 13, wherein the stylus is composed of a conductive material and is configured to be conductively connected to the user.

15. The apparatus of claim 10 wherein the nubs are oriented in planes non-parallel to one another.

16. The apparatus of claim 10 wherein the nubs are oriented in planes parallel to one another.

17. The apparatus of claim 10, wherein the sleeve does not fully enclose the user's fingertip.

18. The apparatus of claim wherein the sleeve is shaped as a ring.

19. The apparatus of claim 10 wherein the sleeve does not fully enclose the circumference of a finger of the user.

20. The apparatus of claim 19, wherein the sleeve is shaped as a portion of a cylinder having a round top portion and a round bottom portion, wherein the cylinder is dissected in a plane parallel to a plane bisecting the round portions of the cylinder.
